(19) United States
(12) Patent Application Publication
(10) Pub. No.: US 2024/0051546 A1
(43) Pub. Date: Feb. 15, 2024

(54) SYSTEM FOR OPERATING OFF-ROAD ELECTRIC VEHICLES

(71) Applicant: FORD GLOBAL TECHNOLOGIES, LLC, Dearborn, MI (US)

(72) Inventors: Gregory KUCAB, Ypsilanti, MI (US); Jacob Gregory POWERS, Livonia, MI (US); David Michael HORAN, Northville, MI (US); Mark A. PELLERIN, Saline, MI (US)

(21) Appl. No.: 17/886,647

(22) Filed: Aug. 12, 2022

(51) Int. Cl. B60W 40/09; B60W 40/101; B60W 20/20

(52) U.S. Cl. CPC B60W 40/09; B60W 40/101; B60W 20/20; B60W 2300/185

(57) ABSTRACT

A vehicle power system includes a motor, a battery, and one or more controllers. The motor is configured to propel the vehicle. The battery is configured to supply power to the motor. The one or more controllers are programmed to, responsive to detecting a wheel slip or a longitudinal tractive force being outside a preferred range, adjust an accelerator pedal mapping such that a same amount of accelerator pedal travel before the adjustment corresponds to an amount of mechanical power output by the motor that is different than an amount of mechanical power output by the motor after the adjustment.

### TECHNICAL FIELD

The present disclosure relates to a method for operating an electric vehicle (EV). More specifically, the present disclosure relates to a method for operating an EV in an off-roading scenario and providing driving instructions.

### BACKGROUND

Unlike conventional vehicles, EVs are propelled by one or more electric motors powered by one or more traction batteries. Due to the nature of the electric motors and batteries, EV powertrains may behave differently compared to conventional internal combustion engine powertrains. The difference in powertrain behavior may be significant when driving off road. In addition, the motors generate little sound compared to conventional vehicle engines and therefore the driver may be unable to rely on sound feedback to determine vehicle operating conditions.

### SUMMARY

A vehicle power system includes a motor, a battery, and one or more controllers. The motor is configured to propel the vehicle. The battery is configured to supply power to the motor. The one or more controllers are programmed to, responsive to detecting a wheel slip or a longitudinal tractive force being outside a preferred range, adjust an accelerator pedal mapping such that a same amount of accelerator pedal travel before the adjustment corresponds to an amount of mechanical power output by the motor that is different than an amount of mechanical power output by the motor after the adjustment.

A vehicle power system includes a first motor, a second motor, a battery, and one or more controllers. The first motor is configured to drive front wheels. The second motor is configured to drive rear wheels. The battery is configured to supply electric power to the first and second motors. The one or more controllers are programmed to, responsive to detecting a wheel slip being outside a preferred range that is defined by a user profile of a driver, enter a mode in which the power being supplied to one of the motors driving the wheels at which the wheel slip is detected is reduced and the electric power supplied to the other one of the motors is increased.

A method for a vehicle includes responsive to detecting a wheel slip or a longitudinal tractive force being outside a preferred range, automatically steering the vehicle such that the wheel slip is reduced or the longitudinal tractive force increases without reducing mechanical power output by a motor of the vehicle.

### BRIEF DESCRIPTION OF THE DRAWINGS

FIG. 1 illustrates an example block topology of an electrified vehicle illustrating drivetrain and energy storage components.

FIG. 2 illustrates an example block topology of a vehicle system.

FIG. 3 illustrates an example flow diagram of a process for operating the vehicle in an off-road driving mode.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure, among other things, proposes a system and method for operating an EV off road.

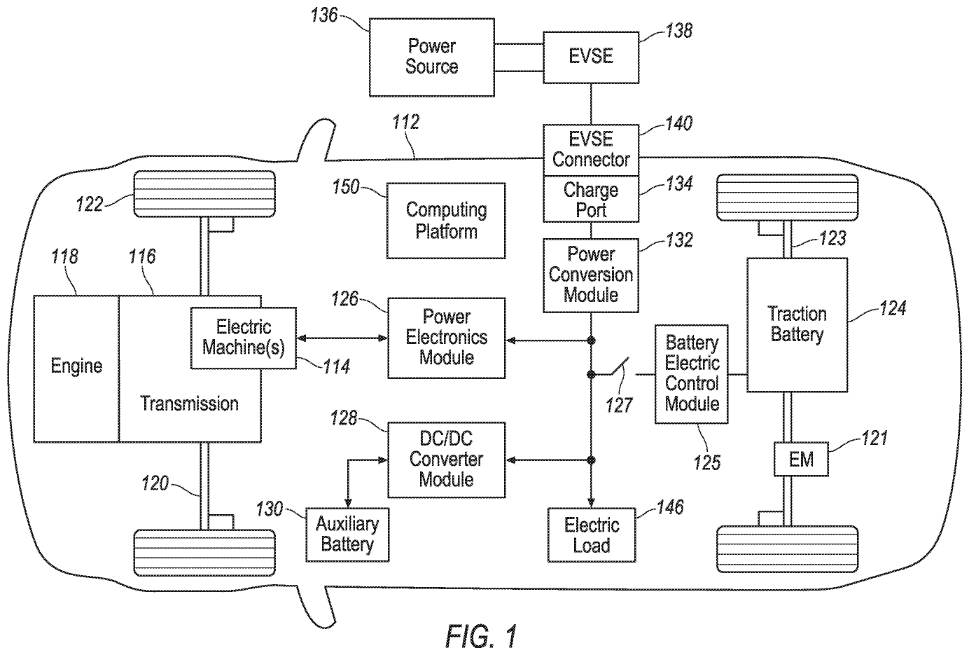

FIG. 1 illustrates a plug-in hybrid-electric vehicle (PHEV). A plug-in hybrid-electric vehicle 112 may comprise one or more electric machines (electric motors) 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft (e.g. a front drive shaft 120) that is mechanically coupled to the wheels 122. The electric machines 114 may provide propulsion and deceleration capability when the engine 118 is turned on or off. The electric machines 114 may also act as generators and may provide fuel economy benefits by recovering energy that would be lost as heat in the friction braking system. The electric machines 114 may also reduce vehicle emissions by allowing the engine 118 to operate at more efficient speeds and allowing the hybrid-electric vehicle 112 to be operated in electric mode with the engine 118 off under certain conditions. Additionally or alternatively, the vehicle 112 may be provided with a plurality of electric machines 114 configured to propel the front and rear wheels independently. For instance, a second electric machine 121 may be coupled to a rear drive shaft 123 and drive the rear wheels independently from the electric machine 114 driving the front wheels.

A traction battery or battery pack 124 stores energy that may be used by the electric machines 114. A vehicle battery pack 124 may provide a high voltage DC output. The traction battery 124 may be electrically coupled to one or more battery electric control modules (BECM) 125. The BECM 125 may be provided with one or more processors and software applications configured to monitor and control various operations of the traction battery 124. The traction battery 124 may be further electrically coupled to one or more power electronics modules 126. The power electronics module 126 may also be referred to as a power inverter. One or more contactors 127 may isolate the traction battery 124 and the BECM 125 from other components when opened and couple the traction battery 124 and the BECM 125 to other components when closed. The power electronics module 126 may also be electrically coupled to the electric machines 114 and provide the ability to bi-directionally transfer energy between the traction battery 124 and the electric machines 114. For example, a traction battery 124 may provide a DC voltage while the electric machines 114 may operate using a three-phase AC current. The power electronics module 126 may convert the DC voltage to a three-phase AC current for use by the electric machines 114. In a regenerative mode, the power electronics module 126 may convert the three-phase AC current from the electric machines 114 acting as generators to the DC voltage compatible with the traction battery 124. The description herein is equally applicable to a pure electric vehicle. For a pure electric vehicle, the hybrid transmission 116 may be a gear box connected to the electric machine 114 and the engine 118 may not be present.

In addition to providing energy for propulsion, the traction battery 124 may provide energy for other vehicle electrical systems. A vehicle may include a DC/DC converter module 128 that converts the high voltage DC output of the traction battery 124 to a low voltage DC supply that is compatible with other low-voltage vehicle loads. An output of the DC/DC converter module 128 may be electrically coupled to an auxiliary battery 130 (e.g., 12V battery).

The vehicle 112 may be a battery electric vehicle (BEV) or a plug-in hybrid electric vehicle (PHEV) in which the traction battery 124 may be recharged by an external power source 136. The external power source 136 may be a connection to an electrical outlet. The external power source 136 may be an electrical power distribution network or grid as provided by an electric utility company. The external power source 136 may be electrically coupled to electric vehicle supply equipment (EVSE) 138. The EVSE 138 may provide circuitry and controls to regulate and manage the transfer of energy between the power source 136 and the vehicle 112. The external power source 136 may provide DC or AC electric power to the EVSE 138. The EVSE 138 may have a charge connector 140 for plugging into a charge port 134 of the vehicle 112. The charge port 134 may be any type of port configured to transfer power from the EVSE 138 to the vehicle 112. The charge port 134 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically coupled may transfer power using a wireless inductive coupling.

One or more electrical loads 146 may be coupled to the high-voltage bus. The electrical loads 146 may have an associated controller that operates and controls the electrical loads 146 when appropriate. Examples of the electrical loads 146 may be a heating module, an air-conditioning module, or the like.

The various components discussed may have one or more associated controllers to control and monitor the operation of the components. The controllers may communicate via a serial bus (e.g., Controller Area Network (CAN)) or via discrete conductors. A computing platform 150 may be present to coordinate the operation of the various components. It is noted that the computing platform 150 is used as a general term and may include one or more controller devices configured to perform various operations in the present disclosure. The system controller 150 individually or in combination with other components of the vehicle shown or not shown, may be programmed to perform various operations of the vehicle 112.

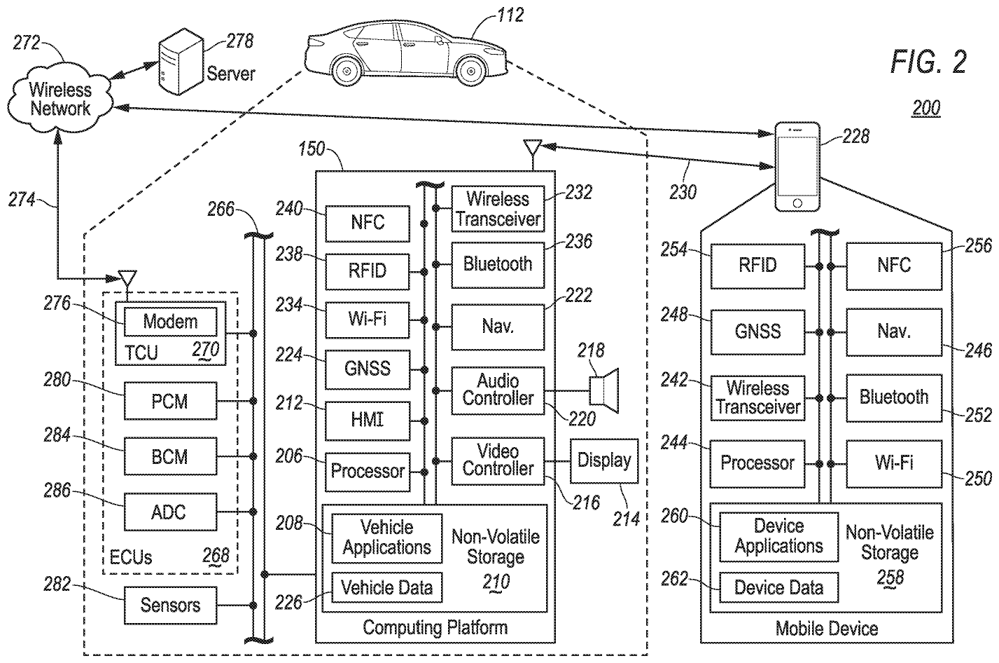

Referring to FIG. 2, an example block topology of a vehicle system 200 of one embodiment of the present disclosure is illustrated. As an example, the system 200 may include the SYNC system manufactured by The Ford Motor Company of Dearborn, Michigan. It should be noted that the illustrated system 200 is merely an example, and more, fewer, and/or differently located elements may be used.

As illustrated in FIG. 2, the computing platform 150 may include one or more processors 206 configured to perform instructions, commands, and other routines in support of the processes described herein. For instance, the computing platform 150 may be configured to execute instructions of vehicle applications 208 to provide features such as vehicle operation controls, multimedia input/output, and wireless communications. Such instructions and other data may be maintained in a non-volatile manner using a variety of types of computer-readable storage medium 210. The computer-readable medium 210 (also referred to as a processor-readable medium or storage) includes any non-transitory medium (e.g., tangible medium) that participates in providing instructions or other data that may be read by the processor 206 of the computing platform 150. Computer-executable instructions may be compiled or interpreted from computer programs created using a variety of programming languages and/or technologies, including, without limitation, and either alone or in combination, Java, C, C++, C #, Objective C, Fortran, Pascal, Java Script, Python, Perl, and SQL.

The computing platform 150 may be provided with various features allowing the vehicle occupants/users to interface with the computing platform 150. For example, the computing platform 150 may receive input from HMI controls 212 configured to provide for occupant interaction with the vehicle 112. As an example, the computing platform 150 may interface with one or more buttons, switches, knobs, or other HMI controls configured to invoke functions on the computing platform 150 (e.g., steering wheel audio buttons, a push-to-talk button, instrument panel controls, etc.).

The computing platform 150 may also drive or otherwise communicate with one or more displays 214 configured to provide visual output to vehicle occupants by way of a video controller 216. In some cases, the display 214 may be a touch screen further configured to receive user touch input via the video controller 216, while in other cases the display 214 may be a display only, without touch input capabilities. The computing platform 150 may also drive or otherwise communicate with one or more speakers 218 configured to provide audio output and input to vehicle occupants by way of an audio controller 220.

The computing platform 150 may also be provided with navigation and route planning features through a navigation controller 222 configured to calculate navigation routes responsive to user input via, for example, the HMI controls 212, and output planned routes and instructions via the speaker 218 and the display 214. Location data that is needed for navigation may be collected from a global navigation satellite system (GNSS) controller 224 configured to communicate with multiple satellites and calculate the location of the vehicle 112. The GNSS controller 224 may be configured to support various current and/or future global or regional location systems such as global positioning system (GPS), Galileo, Beidou, Global Navigation Satellite System (GLONASS) and the like. Map data used for route planning may be stored in the storage 210 as a part of the vehicle data 226. Navigation software may be stored in the storage 210 as one the vehicle applications 208.

The computing platform 150 may be configured to wirelessly communicate with a mobile device 228 of the vehicle users/occupants via a wireless connection 230. The mobile device 228 may be any of various types of portable computing devices, such as cellular phones, tablet computers, wearable devices, smart watches, smart fobs, laptop computers, portable music players, or other devices capable of communication with the computing platform 150. A wireless transceiver 232 may be in communication with a Wi-Fi controller 234, a Bluetooth controller 236, a radio-frequency identification (RFID) controller 238, a near-field communication (NFC) controller 240, and other controllers such as a Zigbee transceiver, an IrDA transceiver, an ultra-wide band (UWB) controller (not shown), and be configured to communicate with a compatible wireless transceiver 242 of the mobile device 228.

The mobile device 228 may be provided with a processor 244 configured to perform instructions, commands, and other routines in support of the processes such as navigation, telephone, wireless communication, and multi-media processing. For instance, the mobile device 228 may be provided with location and navigation functions via a navigation controller 246 and a GNSS controller 248. The mobile device 228 may be provided with the wireless transceiver 242 in communication with a Wi-Fi controller 250, a Bluetooth controller 252, a RFID controller 254, an NFC controller 256, and other controllers (not shown), configured to communicate with the wireless transceiver 232 of the computing platform 150. The mobile device 228 may be further provided with a non-volatile storage 258 to store various mobile applications 260 and mobile data 262.

The computing platform 150 may be further configured to communicate with various components of the vehicle 112 via one or more in-vehicle networks 266. The in-vehicle network 266 may include, but is not limited to, one or more of a controller area network (CAN), an Ethernet network, and a media-oriented system transport (MOST), as some examples. Furthermore, the in-vehicle network 266, or portions of the in-vehicle network 266, may be a wireless network accomplished via Bluetooth low-energy (BLE), Wi-Fi, UWB, or the like.

The computing platform 150 may be configured to communicate with various electronic control units (ECUs) 268 of the vehicle 112 configured to perform various operations. The computing platform 150 may be configured to communicate with a TCU 270 configured to control telecommunication between the vehicle 112 and a wireless network 272 through a wireless connection 274 using a modem 276. The wireless connection 274 may be in the form of various communication networks, for example, a cellular network. Through the wireless network 272, the vehicle may access one or more servers 278 to access various content for various purposes. It is noted that the terms wireless network and server are used as general terms in the present disclosure and may include any computing network involving carriers, router, computers, controllers, circuitry or the like configured to store data and perform data processing functions and facilitate communication between various entities. The ECUs 268 may further include a powertrain control module (PCM) 280 configured to operate the powertrain of the vehicle 112 based on operation data received from one or more sensors 282. The sensors 282 may include one or more sensing devices configured to measure various data related to operating conditions for the vehicle 112. As a few non-limiting examples, the sensors 282 may include wheel speed sensors configured to measure the rotation speed of each wheel such that a wheel slip ratio may be detected and determined by the PCM 280. The sensors 282 may further include one or more torque sensors configured to measure a collective vehicle torque and/or an individual wheel torque in the longitudinal direction of the vehicle 112. Additionally, the sensors 282 may further include one or more cameras configured to capture images, tire pressure sensors, temperature sensors, humidity sensors, gyroscopes configured to measure the level of the vehicle or the like. The PCM 280 may be configured to adjust the anti-lock braking (ABS), traction control, electronic stability control (ESC) settings of the vehicle while driving off-road. For instance, responsive to detecting a wheel slip ratio exceeding a threshold and the lack of longitudinal torque suggesting the one or more wheels are slipping, the PCM 280 may reduce the traction control and ESC settings to allow the spinning wheels to continue slipping. The ECUs 268 may further include a body control module (BCM) 284 configured to control the vehicle body operation. For instance, the BCM 284 may adjust the stiffness and/or height of the suspension of the vehicle 112 to accommodate various off-roading conditions. The ECUs 268 may further include an autonomous driving controller (ADC) 286 configured to control an autonomous driving feature of the vehicle 112. For instance, responsive to detecting a predefined off-road condition, the ADC 286 may autonomously operate vehicle functions such as steering, braking, speed control, etc. in addition to or in lieu of the driver input to assist the off-road driving.

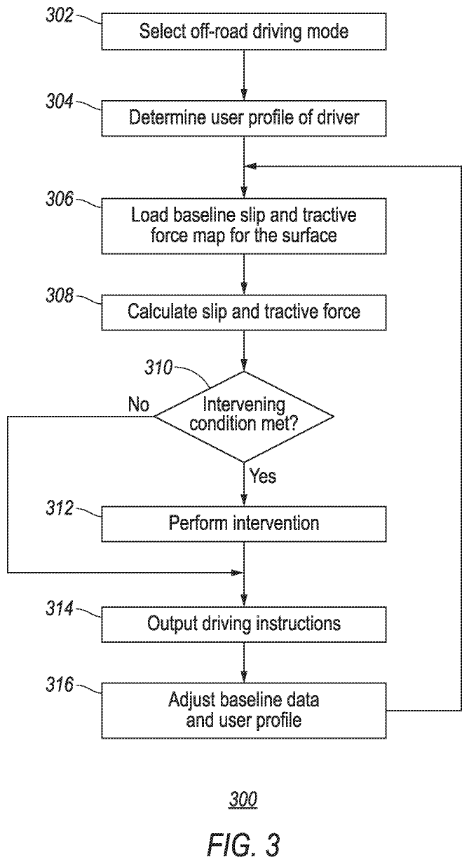

Referring to FIG. 3, an example flow diagram of a process 300 for operating the vehicle in the off-road mode and providing driving instructions is illustrated. With continuing reference to FIGS. 1 and 2, the process 300 may be implemented using various components of the vehicle 112. For instance, the process 300 may be implemented via one or more of the computing platform 150, the PCM 280, the BCM 284, the ADC 186 and/or other components shown or not shown independently or collectively. For simplicity, the following description will be made primarily with reference to the computing platform 150 although the present disclosure is not limited thereto. At operation 302, responsive to the computing platform 150 detecting a user manually selecting one of a plurality of off-road driving modes supported by the vehicle 112, the computing platform 150 and/or the PCM 280 switches to the user selected driving mode. As an example, the driver may select the driving mode using an input device (e.g. a knob or a button) via the HMI controls 212. Alternatively, the driver may change the driving mode using a voice command via a microphone (not shown) through the audio controller 220. Depending on the configuration of the vehicle 112 one or more pre-programmed off-road driving modes may be provided. For instance, the vehicle 112 may be provided with a mud mode for muddy driving conditions, a sand mode for sandy driving conditions, a snow mode for snow/ice driving conditions on paved or unpaved roads or the like. Additionally, the vehicle 112 may be provided with an automatic driving mode selection feature configured to allow the vehicle 112 to automatically switch between different driving modes based on various data received. The computing platform 150 may automatically detect a driving condition under which the one or more pre-programmed off-road modes is applicable. For instance, the computing platform 150 may detect slippery road conditions using data from the sensors 282. Additionally or alternatively, the computing platform 150 may detect the vehicle 102 is currently being driven on an unpaved surface (e.g. sand, mud) using the location data from the GNSS controller 224. Additionally or alternatively, the computing platform 150 may detect a weather condition corresponding to one or more of the pre-programmed driving conditions (e.g. snow, icy road) using weather data received from the server 278 via the TCU 270.

At operation 304, the computing platform 150 determines a user profile associated with the driver operating the vehicle 112. The user profile may include information indicative of the driver's history and experience driving in off-road conditions. For instance, if the user profile indicates the driver is experienced in operating vehicles in the selected driving condition, it may be unnecessary for the vehicle 112 to actively intervene with the driving control or provide driving instructions. Otherwise, if the driver is inexperienced or not recognized by the vehicle 112, the vehicle 112 may provide more interventions and instructions to assist the driver operating the vehicle in the selected driving mode. The user profile may be received from the mobile device 228 as a part of the mobile data 262 associated with the driver. Additionally or alternatively, the user profile may be stored in the storage 210 as a part of the vehicle data 226. The computing platform 150 may be configured to store multiple user profiles in the storage 210 and identify the corresponding user as the driver via various means. For instance, the computing platform 150 may identify the driver by asking the driver to make an identification input to the touch screen 214. Additionally or alternatively, the computing platform 150 may identify the driver via biometric means via an in-cabin camera (not shown) configured to capture a facial image of the user on the driver seat. The computing platform 150 may be further configured to analyze the facial image to identify the driver as well as the corresponding user profile. At operation 306, the PCM 280 loads baseline data corresponding to the selected driving mode. The PCM 280 may be provided with a non-volatile storage (not shown) to store the data. Alternatively, the slip ratio and longitudinal tractive force map data may be stored in the storage 210. As an example, the baseline data may include a baseline wheel slip ratio and longitudinal tractive force map data corresponding to the selected driving mode. It is noted that the present disclosure is not limited thereto and other data and parameters may be included in the baseline data depending on the specific design need. The baseline data may include pre-programmed baseline slip ratio and longitudinal tractive force parameters corresponding to the selected driving mode regardless of the driver. Alternatively, the baseline pre-programmed slip ratio and longitudinal tractive force parameters may be customized/adjusted for the driver as identified using the user profile. The baseline slip ratio and longitudinal tractive force parameters may be indicative of a range within which the vehicle operation is preferred. For instance, the baseline slip ratio parameter may be indicative of a threshold within which a rotation speed difference between the vehicle wheels is preferred/tolerated. The baseline longitudinal tractive force parameter may be indicative of a range within which a tractive force on the longitudinal direction of the vehicle is preferred. Responsive to detecting the actual vehicle parameters are beyond the range, the vehicle 112 may perform an intervening action to bring the vehicle operation back to the range. As an example, if little tractive force on the longitudinal direction is detected even when the vehicle wheels rotate at a high rate of speed, (e.g. beyond the baseline longitudinal tractive force parameter range), suggesting the vehicle is on a slippery surface, an intervening action may be performed.

At operation 308, the PCM 280 calculates parameter data such as the actual vehicle wheel slip ratio and tractive force data based on sensor input, and compares the actual data with the baseline data to determine if an intervening condition is met. The intervening condition may be determined and triggered in various manners. As discussed above, one or more thresholds defining a preferred operation range may be associated with the baseline parameter data. Responsive to the actual data exceeding the threshold which is indicative of the operating condition of the vehicle 112 being beyond the range that is preferred for the selected driving mode, the PCM 280 may determine the intervention condition is met and an intervention action corresponding to the detected intervention condition may be performed. In addition, multiple levels of intervention conditions based on different thresholds may be used. Each level of intervention condition may correspond to different intervention actions. For instance, responsive to detecting a minor degree of wheel slip meeting a first level of intervention condition, the PCM 280 may lock the axel for the slipping wheel. However, if both wheels on the locked axle start to slip which meets a second level of intervention condition, the PCM 280 may perform an escalated intervention by modifying the power distribution and shift the power output to the other axle. The shifting of the power distribution may be performed by operating the electric machine driving each axle with different power output. Using the example illustrated with reference to FIG. 1, in response to detecting the front wheels slipping, the PCM 280 may reduce the power for the front electric machine 114 and increase the driving power for the rear electric machine 121.

At operation 310, responsive to detecting an intervening condition being met, the process proceeds to operation 312 and the PCM 280 performs the corresponding intervention action to facilitate the off-road driving. For instance, the intervention may include adjusting accelerator and/or brake pedal mapping, such that a same amount of accelerator pedal travel before the adjustment corresponds to an amount of mechanical power output by the motor that is different than that amount of mechanical power output by the motor after the adjustment. In one embodiment, responsive to detecting a wheel slip, the PCM 280 may adjust the accelerator mapping such that the same amount of pedal travel may correspond to a reduced power output from the motors. Additionally or alternatively, the intervention may further include adjusting traction control and ABS settings, locking/unlocking driving axles, adjusting suspension stiffness and height, changing torque ratio for each wheel or the like. Additionally, in anticipation of a large amount of power output, the vehicle 112 may increase the cooling for the battery 124 and/or electric motors 114 and 121. Additionally, in certain predefined situations, the vehicle 112 may partially or entirely take over the driving controls via the ADC 286 to prevent an undesirable situation (e.g. trapping in sand). For instance, the ADC 286 may automatically steer the vehicle and/or control the accelerator/brake pedal until detecting the driving condition has deescalated and the actual parameters have returned to the preferred range. As an example, the ADC 286 may autonomously steer the vehicle such that one or more of the vehicle tires have an increased contact surface area with ground to increase the tractive force. In addition, at operation 314, the computing platform 150 outputs driving instructions via the display 214 and/or the speaker 218 to assist the driver to operate the vehicle 112 off road. The driving instructions may include various recommendations that instruct the driver to operate the vehicle within the predefined parameter range. Taking the sand mode for instance, driving too slowly or stopping on a sandy surface is generally not preferred. Responsive to detecting the vehicle speed and/or the longitudinal tractive force is below a predefined threshold while in the sand mode, the computing platform 150 may output driving instructions to ask to driver to increase the vehicle speed. If the driver does not respond to the driving instructions, the vehicle 112 may escalate the intervention and autonomously increase vehicle speed (when the situation allows) to prevent an undesirable situation until the vehicle has overcome the driving situation and the vehicle may deactivate the autonomous driving feature to give back the control to the driver. If the intervening conditions are not met, the process proceeds from operation 310 to 314 without performing intervening actions. At operation 316, the computing platform 150 and/or PCM 280 adjust/update the baseline parameters based on the actual data as measured to strengthen the off-road experience for the driver. The computing platform 150 further updates the user profile associated with the driver. For instance, responsive to the driver successfully overcoming a driving condition, the computing platform 150 may increase the experience level of the user profile such the next time when the driver encounters the driving condition, vehicle interventions may be reduced.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle power system comprising:
a motor configured to propel the vehicle;
a battery configured to supply power to the motor; and
one or more controllers programmed to, responsive to detecting a wheel slip or a longitudinal tractive force being outside a preferred range, adjust an accelerator pedal mapping such that a same amount of accelerator pedal travel before the adjustment corresponds to an amount of mechanical power output by the motor that is different than an amount of mechanical power output by the motor after the adjustment.

2. The vehicle of claim 1, wherein the one or more controllers are further programmed to modify boundary values of the preferred range based on a user profile of a driver.

3. The vehicle of claim 1, wherein the one or more controllers are further programmed to, responsive to input of a driver resulting in the wheel slip or longitudinal tractive force returning to the preferred range, return the accelerator pedal mapping to initial conditions.

4. The vehicle of claim 3, wherein the one or more controllers are further programmed to, for the particular driver, inhibit further adjustments to the accelerator pedal mapping after the wheel slip or longitudinal tractive force returns to the preferred range.

5. The vehicle of claim 3, wherein the one or more controllers are further programmed to, for the particular driver, reduce a likelihood that adjustments to the accelerator pedal mapping will be made after the wheel slip or longitudinal tractive force returns to the preferred range.

6. The vehicle of claim 1, wherein the one or more controllers are further programmed to, responsive to the detecting, increase cooling for the battery.

7. The vehicle of claim 1, wherein the preferred range is defined by a location of the vehicle.

8. A vehicle power system comprising:
a first motor configured to drive front wheels;
a second motor configured to drive rear wheels;
a battery configured to supply electric power to the first and second motors; and
one or more controllers programmed to, responsive to detecting a wheel slip being outside a preferred range that is defined by a user profile of a driver, enter a mode in which the electric power being supplied to one of the motors driving the wheels at which the wheel slip is detected is reduced and the electric power supplied to the other one of the motors is increased.

9. The vehicle system of claim 8, wherein the one or more controllers are further programmed to, responsive to input of the driver resulting in the wheel slip returning to the preferred range, exit the mode.

10. The vehicle power system of claim 9, wherein the one or more controllers are further programmed to, for the particular driver, inhibit entering the mode after the wheel slip returns to the preferred range.

11. The vehicle power system of claim 9, wherein the one or more controllers are further programmed to, for the particular driver, reduce a likelihood that the mode will be entered after the wheel slip returns to the preferred range.

12. The vehicle power system of claim 8, wherein the one or more controllers are further programmed to, responsive to the detecting, increase cooling for the battery.

13. A method for a vehicle, comprising:
responsive to detecting a wheel slip or a longitudinal tractive force being outside a preferred range, automatically steering the vehicle such that the wheel slip is reduced or the longitudinal tractive force increases without reducing mechanical power output by a motor of the vehicle.

14. The method of claim 13 further comprising modifying boundary values of the preferred range based on a user profile of a driver.

15. The method of claim 13 further comprising, responsive to input of a driver resulting in the wheel slip or longitudinal tractive force returning to the preferred range, discontinuing the automatically steering.

16. The method of claim 15 further comprising, for the particular driver, inhibiting the automatically steering after the wheel slip or longitudinal tractive force returns to the preferred range.

17. The method of claim 15 further comprising, for the particular driver, reducing a likelihood the automatically steering will occur after the wheel slip or longitudinal tractive force returns to the preferred range.

18. The method of claim 13 further comprising, responsive to the detecting, increasing cooling for a battery of the vehicle.

19. The method of claim 13, wherein the preferred range is defined by a location of the vehicle.
